(19) United States
(12) Patent Application Publication
(10) Pub. No.: US 2021/0069920 A1
(43) Pub. Date: Mar. 11, 2021

(54) PIVOTING ROTARY 4 BLADE RAZOR HEAD

(71) Applicant: SKULL SHAVER, LLC, MOORESTOWN, NJ (US)

(72) Inventor: NEEL B. KULSHRESHTHA, BURLINGTON TOWNSHIP, NJ (US)

(21) Appl. No.: 16/561,292

(22) Filed: Sep. 5, 2019

(51) Int. Cl. B26B 19/14; B26B 19/38

(52) U.S. Cl. CPC B26B 19/146; B26B 19/386

(57) ABSTRACT

A 4 blade electric shaver head adapted to be connected to an electric shaver that includes a handle and an electric motor for operating the shaver head. The head includes four rotary cutters arranged in a square configuration and four holders also arranged in a square configuration. Each of the holders holds one of the cutters. The inner edges of the four holders define a point at the center of the shaver head. A housing for the holders includes an upper surface. The holders are retained by the housing but are mounted for pivotal movement such that the inner edges and outer edges can move up and down. A spring biases the holders in a position wherein the outer edges lie above the upper surface of the housing and wherein the holders slant downwardly toward the center thereby forming a concave shaving surface. The holders are interconnected to each other so as to always pivot in unison.

### BACKGROUND OF THE INVENTION

The present invention is directed toward a rotary electric razor or shaver and, more particularly, toward the rotating shaving head for the same that includes four rotary cutters that are designed to more smoothly and effectively shave various parts of a person's body.

The pivoting rotary 4 blade razor head of the present invention is particularly adapted to be used with the razor or shaver such as shown in one of the present applicant's U.S. Pat. Nos. 8,726,528 and D693,060. However, it could possibly be used in association with substantially any shaver or razor that incorporates rotary shaving heads, such as, for example, the shavers shown in U.S. Pat. Nos. 7,370,420; 8,393,082 and 9,174,349.

While prior rotary blade razors have met with some success, they all suffer from various deficiencies. Some have fixed rotary cutting elements that do not pivot or flex as the shaver is moved over various body parts being shaved. Others have rotary cutting elements that may pivot but are arranged in a flat or convex arrangement. Most body parts, however, are more convex themselves. Thus, a shaver that is more concave is believed to be more beneficial. Furthermore, the prior shavers employ rotary cutting elements that are flush with the holders therefore limiting the ability for air to enter for cooling purposes. Even further, with most prior art shavers of this type, there is nothing to prevent the rotary cutters from moving downwardly when forces are applied which can cause damage to the same during use.

There is, therefore, a need for an electric shaver head that more accurately follows the parts of the body being shaved and which is air cooled and helps to prevent damage for excess forces being applied.

### SUMMARY OF THE INVENTION

The present invention is believed to overcome the deficiencies of the prior art discussed above. The 4 blade electric shaver head of the invention is adapted to be connected to an electric shaver that includes a handle and an electric motor for operating the shaver head. The head includes four rotary cutters arranged in a square configuration and four holders also arranged in a square configuration. Each of the holders holds one of the cutters. The inner edges of the four holders define a point at the center of the shaver head. A housing for the holders includes an upper surface. The holders are retained by the housing but are mounted for pivotal movement such that the inner edges and outer edges can move up and down. A spring biases the holders in a position wherein the outer edges lie above the upper surface of the housing and wherein the holders slant downwardly toward the center thereby forming a concave shaving surface. The holders are interconnected to each other so as to always pivot in unison.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form that is presently preferred; it being understood that the invention is not intended to be limited to the precise arrangements and instrumentalities shown.

FIG. 1 is a top perspective view of a pivoting rotary 4 blade razor head constructed in accordance with the invention;

FIG. 2 is a side elevational view with the cutters in their normally biased position;

FIG. 3 is a side elevational view similar to FIG. 2 but with the cutters moved downwardly in use;

FIG. 4 is a cross-sectional view taken through the line 4-4 of FIG. 2, and

FIG. 5 is an exploded view of the invention showing the internal parts thereof.

### DETAILED DESCRIPTION OF THE PREFERRED EMBODIMENT

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

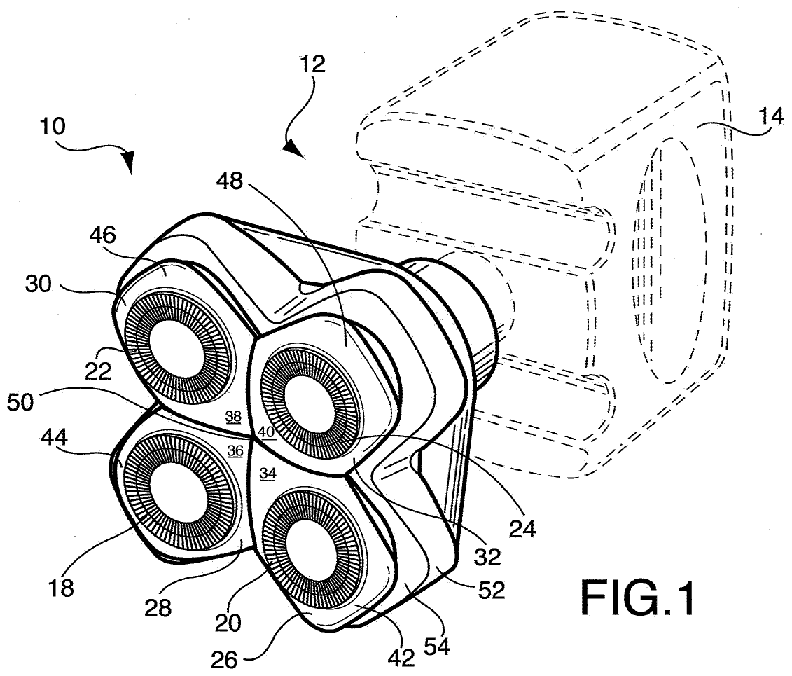

Referring now to the drawings in detail wherein like reference numerals have been used throughout the various figures to designate like elements, there is shown in FIGS. 1-5 a pivoting rotary 4 blade razor head constructed in accordance with the principles of the present invention and designated generally as 10.

The pivoting rotary 4 blade razor head 10 is adapted to be part of a complete electric razor 12 that includes a handle 14 that has an electric motor (not shown) therein to operate the razor head 10. Preferably, also included within the handle 14 is a rechargeable battery for powering the motor. The head 10 is connected to the handle 14 through the stem 16 which also interconnects the motor to the operative parts of the head in the manner well known in the art. The motor and battery and the interconnection between the motor razor head are all well known in the art as shown and described, for example, in the above patents. Accordingly, a detailed description thereof is not believed to be necessary.

The head 10 is comprised essentially of four rotary cutters 18, 20, 22 and 24 arranged in a square configuration. The cutters 18, 20, 22 and 24 are also, per se, well known in the art so that a detailed description thereof is not necessary. In any event, each cutter 18, 20, 22 and 24 is held within a different holder 26, 28, 30 and 32, respectively. The holders, like the cutters, are also arranged in a square configuration. As is also well known in the art, the cutters 18, 20, 22 and 24 can be mounted for limited movement in and out of the holders 26, 28, 30 and 32 but are normally biased outwardly.

Each of the holders 26, 28, 30 and 32 has an inner edge 34, 36, 38 and 40, respectively, and an outer edge 42, 44, 46 and 48, respectively. As shown most clearly in FIG. 1, the inner edges of the four holders define a point 50 at the center of the shaver head 10.

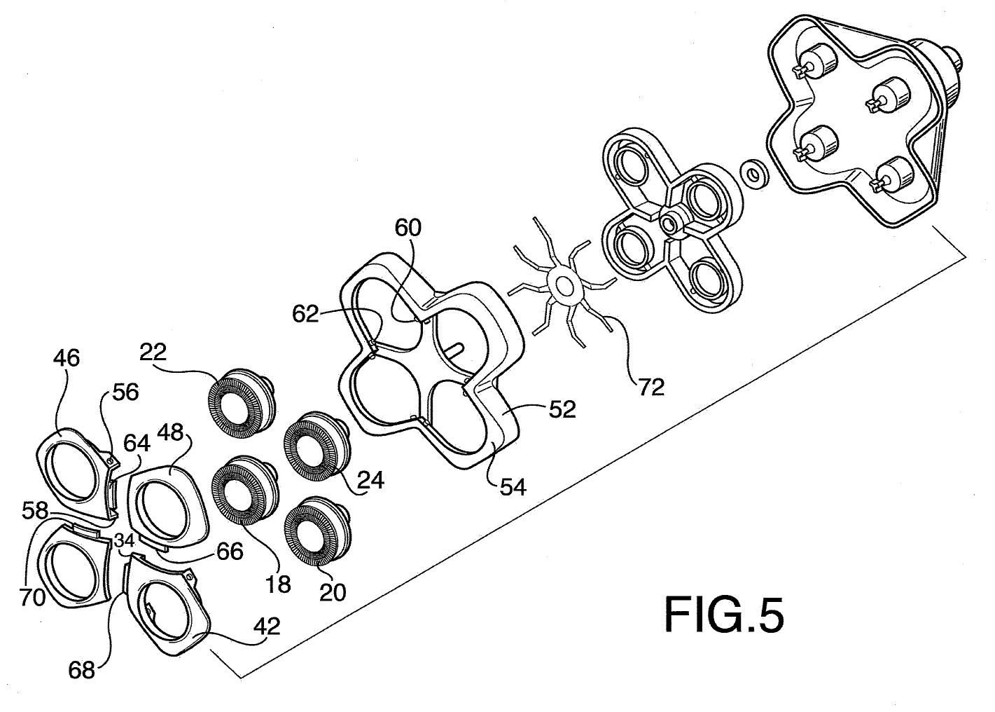

The holders themselves are retained in or carried by a housing 52 having an upper surface 54. Each holder, however, is mounted within the housing 52 so as to allow for pivotal movement. As shown most clearly in FIG. 5, this is accomplished through the use of a plurality of pivot pins and openings. Holder 30, for example, includes a pair of openings 56 and 58 on the sides thereof. Corresponding pivot pins 60 and 62 are carried by the housing 52 and fit within the openings 56 and 58. This allows the holder 30 to pivot slightly about the axis defined by the pins 60 and 62.

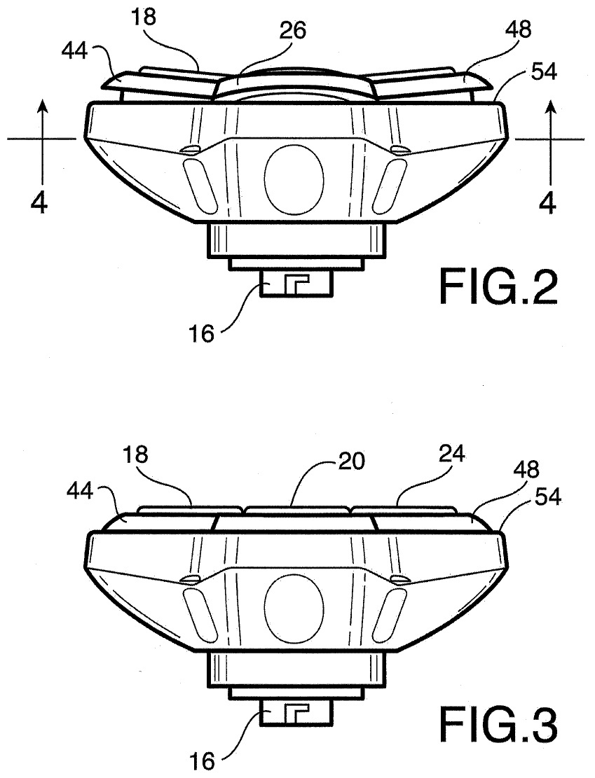

Each of the other holders includes similar openings and corresponding pins which are carried by the housing 52 as shown in FIG. 5. Accordingly, all of the holders can pivot in essentially the same manner as the holder 30 just described. As best seen in FIGS. 2 and 3, pivoting of the holders permits their inner and outer edges to move up and down. Furthermore, each of the holders includes a tab 64, 66, 68 and 70 that fits under the holder next to it. In this way all of the holders are forced to move in unison. As any one pivots, they all pivot.

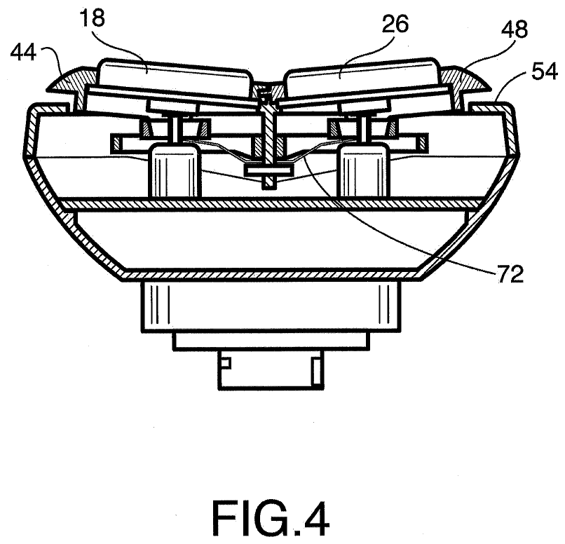

A spring 72 exerts an upward force on each of the outer edges of each of the holders thereby biasing them upwardly into the positions shown in FIGS. 2 and 4. That is, all of the holders slant downwardly toward the center 50 thereby forming a concave shaving surface. This is believed to be most advantageous as most body parts being shaved are primarily convex. In addition, when in the biased position, the outer edges 42, 44, 46 and 48 of the holders lie above the upper surface 54 of the housing 52. This arrangement keeps the inner workings of the head 10 cooler and makes it easier to clean. Of course, the holders can flex into the position shown in FIG. 3 when in use. However, the outer edges are essentially in the form of flanges that contact the upper surface 54 of the housing when moved into the position shown in FIG. 3 to prevent them from moving too far down or inwardly thereby preventing damage.

The present disclosure has been described with reference to an exemplary embodiment. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A four-blade electric shaver head for use with and adapted to be part of a completed electric shaver that includes a handle and an electric motor within said handle for operating said shaver head, said shaver head comprising:
four rotary cutters arranged in a square configuration;
four holders arranged in a square configuration, each of said holders holding a different one of said four rotary cutters, each of said holders having an inner edge and an outer edge, said inner edges of said four holders defining a point at the center of said shaver head;
a housing for said holders, said housing having an upper surface;
said holders being retained by said housing but being mounted for pivotal movement whereby said inner edges and said outer edges can move up and down;
means biasing said holders in a position wherein said outer edges lie above said upper surface of said housing and wherein said holders slant downwardly toward said center thereby forming a concave shaving surface, and
means for operatively connecting said shaver head to said handle.

2. The four-blade electric shaver head as claimed in claim 1, wherein said holders are interconnected so as to always pivot in unison with each other.

3. The four-blade electric shaver head as claimed in claim 1, wherein said outer edges of said holders include a flange that overlies and contacts said upper surface when said outer edges are pivoted downwardly.
